(19) United States
(12) Patent Application Publication
(10) Pub. No.: US 2020/0287246 A1
(43) Pub. Date: Sep. 10, 2020

(54) AN ELECTRODE FOR LEAD ACID BATTERY ASSEMBLY AND ITS METHOD OF PREPARATION

(71) Applicant: Amara Raja Batteries Limited, Tirupati (IN)

(72) Inventors: Jagdish MANDAVA, Tirupati (IN); Venkata Kuladeep MACHAVOLU, Tirupati (IN)

(21) Appl. No.: 16/652,437

(22) PCT Filed: Oct. 12, 2018
(86) PCT No.: PCT/IN2018/050653

§ 371 Date: Mar. 31, 2020

(30) Foreign Application Priority Data
Oct. 12, 2017 (IN) 201741036252

(51) Int. Cl. H01M 10/14; H01M 4/66; H01M 4/57; H01M 4/36; H01M 4/20

(52) U.S. Cl. CPC H01M 10/14; H01M 4/667; H01M 4/663; H01M 2004/028; H01M 4/366; H01M 4/20; H01M 4/57

(57) ABSTRACT

The invention relates to a lead acid battery assembly comprising plurality of cells which are disposed within a housing and each cell having two electrodes namely positive plate and negative plate placed in a volume of an electrolyte in the housing. The cell formed comprises as per the invention at least one electrode plate prepared with a multilayered structure comprising a graphite composite material having higher electronic conductivity during charging and discharging of the battery assembly. The electrode plate structure formed is a three layered plate comprises a first base/substrate layer (100) made of electrically conductive material; a second transition layer (110) made of graphite composite material being adhered to the first base layer using an adhesive agent; and a third chemically active conductive layer (120) surrounding the second transition layer (110)

### FIELD OF INVENTION

The invention in general relates to the field of rechargeable storage batteries. More particularly it relates to the electrode preparation and its plate structure to be used in lead acid battery assembly and a method of manufacturing the same.

### BACKGROUND OF THE ART

Typically, the electrochemical batteries namely lead acid batteries, VRLA (valve-regulated lead-acid battery), sealed lead acid batteries (SLA) etc., finds many application in today's world from modern motorcycles, ATVs, home alarm systems, toys, backup systems, workout equipment, generators and the list goes on. These batteries come in all shapes, voltages, amperages and sizes.

When compared with other secondary storage battery technologies, lead acid batteries has some special properties which makes these batteries to play a major role in SLI (Start Lighting and Ignition) of trucks and buses, bikes (automobile industry). Even in UPS, solar, telecom, space craft application these are used. The major disadvantages of these batteries are acid stratification, weight, low charge acceptance and less cyclic life in Psoc (partial state of charge) applications.

As is well known, these Lead-acid storage batteries comprise several electrochemical cell elements which are encased in separate compartments of a container containing sulfuric acid electrolyte (a liquid with free-moving ions). Each cell element includes at least one positive plate, one negative plate and each comprises a lead or lead alloy grid that supports an electrochemically active material. It is also commonly recognized that grids for lead acid batteries provide structural support for the active material therein, and serve as a current collector during discharge and a current distributor during recharge.

Although the advancement in lead acid battery has been made in many ways by research and investigation to improve the battery performance and battery life cycle (during charging and Discharging), some factors in the manufacturing process and configuration of the lead acid battery are still in challenges as it was not yet been fully met. Among them, the two major obstacles which challenges in today's lead acid battery manufacturers are corrosion and sulfation. Corrosion occurs on the positive plate of lead acid battery due to the failure of lead alloy and grid structure when are temperature is increased more than 70° F. or if are battery is not properly charged. The sulfation is another issue which occurs on the negative plate during discharge reaction, due to the formation of lead sulfate crystals (called as hard lead sulfate) that happens when a lead acid battery is kept partially or fully discharged up to 0% of state of charge. As the formation of large lead sulfate crystals could not be converted back into the charged lead and lead dioxide active materials, it will impact the capacity and performance of the battery during each recharge reaction which resulting in incomplete recharging process in the battery or prevent the battery from being recharged. Furthermore repeated cycles of partial charging/discharging will increase the stratification of the electrolyte in lead acid battery i.e., during charging when the density of sulphuric acid is more than water, the acid formed at the plates will flow downward and gets collected at the bottom of the battery.

Carbon plays a vital role in the lead acid batteries technology and provides the beneficial effects in battery capacity and life cycle. Based on the behavior of different forms of carbon materials, this one is used as additives to either positive active material or to either the negative active material in the paste mix in the method of manufacturing of lead acid battery improves the plate conductivity, more specifically in the Psoc operation of hybrid active materials. The chemical structure of carbon materials in any one of the form such as diamond (crystalline), graphite (hexagonal), fullerenes, nanotubes etc., is influenced by the specific area and the composition of the surface.

Accordingly, adding of carbon to the configuration of the battery assembly increase the conductivity of the (negative) plates reducing the resistance offered by hard sulfate formed during discharge, it thereby decrease the overall temperature inside the battery which reduces the effect of temperature on corrosion of positive plate and thereby increasing the cyclic life of the battery. It is also observed that the initial charging (formation) input of the battery is reduced by a considerable extent.

Recent advancements are made in the lead acid battery technology by incorporating the use of carbon foam composite material in the electrode plate configuration to improve the battery performance with high energy storage by overcoming the limitations of both the plates (positive and negative) of battery assembly. There are some problems that not yet been solved in the conventional lead acid battery are carbon foam grid which used in the electrode preparation are very brittle and may subject to fracture of electrode during shock or vibrations. Furthermore, it will not absorb acid resulting in stratification and loss of water concentration in the mixture used in lead acid battery. This occurs due to less carbon foam distribution during charging and recharging.

The disadvantages of the electrode structure in the conventional lead acid battery include the poor acid absorption capacity, non-adhesion of lead paste to the active material within the carbon additives in the plate, decrease in charge acceptance of the battery and thereby reducing the cyclic life of the battery.

Hence, there is an ongoing need in the manufacturing method of battery assembly more specifically in the configuration of the electrode plates used in the battery with an improved battery performance, good acid absorption capacity, and high charge acceptance and maximized battery life cycle. Additionally, there is requirement of electrode structure layer which is fabricated without altering the basic function of lead acid battery by the deploying of an improved carbon foam composite material for the positive and negative electrode plates of lead acid battery. This particular selection of carbon foam composite material should yield electrode structure with rigid pattern having even diffusion of ionic charge in all direction, resulting in good acid absorption capacity and thereby preventing the stratification and reducing the water loss during charging and discharging.

The present invention overcomes the above problems and limitations found in the conventional system of battery assembly and provides a novel and efficient method of preparation of electrode plates in the manufacturing of battery assembly.

### OBJECT OF INVENTION

As discussed in the background of the art to overcome the above challenges, there has been a tremendous effort made by research and investigation in the conventional lead acid battery technology. But still there is need of more improved manufacturing techniques in lead acid battery assembly with some advancement in lead based alloys or grid designs, electrode plate structure to stabilize the current collector behavior.

Thus the object of the present invention is to provide an electrode which is capable of generating high electric energy storage with increased battery life in an efficient manner in a lead acid battery.

It is also an object of the present invention to provide an electrode with at least graphite composite layer with enhanced mechanical and electrical properties that are necessary for maintaining the active material during charging and discharging of lead acid battery.

Yet another object of the invention is to provide an electrode which maintain the structural characteristics and thereby also improve the adhesion between the active material and the graphite composite material.

Further object of the invention is to provide an electrode structure having stability even if the lead acid battery undergoes repeated cycle of charging and discharging (deep) operation.

It is also an object of the present invention to provide an electrode for lead acid battery comprising a multi-layered structure namely a first base layer, a second transition layer and a third conductive active layer covering the second transition layer.

According to the present invention, these objects are achieved by a battery assembly with a configuration of electrode plate preparation using graphite composite material as an stabilizer in any one of the two plates of the cell to provide better charge acceptance (increased by 15% from usual lead acid battery), by enhancing the acid absorption capacity and forming a good bondage between the graphite composite material and lead grid of the plates.

The resultant negative plates and positive plates which formed with a configuration as per the present invention have huge energy generating capacity advantageously over the conventional lead acid grid structure. Consequently, battery performance and capacity is increased even during CIO discharge since there is no observation of decrease (reduction) in capacity even after 30 cycles of 100% DOD (Depth of discharge) and has better cyclic life from usual lead acid battery.

### BRIEF DESCRIPTION OF INVENTION

In accordance with the present invention, the structure of electrode preparation of battery assembly comprising a positive plate (anode) and a negative plate (cathode) which both are immersed in a volume of electrolyte namely sulphuric acid.

More specifically, the configuration of the electrode in the lead acid battery assembly includes a multilayered structure having graphite composite material as per the present invention. This multilayered structure of electrode comprising
a first substrate (grid) layer being an electrically conductively material which is a single flat sheet of material made of lead,
a second transition layer with graphite composite material being attached/adhered to the first substrate layer using an adhesive agent.
a third layer of chemically active material namely Pb, PhO2 which is pasted/deposited on the second transition layer.

The second layer of graphite composite material layer comprises pure graphite 0.1 to 10% of weight (99.6% Carbon purity), which is subjected to a graphitization process with a base of any other synthetic polymer material from 1 to 10% to form a transition layer. This layer is fixed to the first substrate layer by cold pressing using an adhesive agent. The adhesive agent being a material or substance and most preferably a thermosetting resin such as epoxy, epoxy resin, epoxy glue or any cyanoacrylates to provide strong adhesive properties. This graphitization process helps in increasing the electrical conductivity of graphite by providing an electrical connection with the first layer of substrate. Addition of synthetic polymer material with pure graphite exhibits good mechanical support and also enhances adhesion of graphite material with substrate layer and third layer of chemically active material.

During charging, the graphite composite layer attached to the grid of the electrode provides the generation of bisulphate graphite intercalation compound and this graphite composite material presence ensures the more uniform current distribution throughout the plate thickness.

Thus, according to the present invention, electrode cells of lead acid battery are configured to include different graphite composite material thickness as a transition layer not only to transfer the electrical conductivity (electricity) from chemically active material to substrate layer but also serves as a good adhesion layer by holding the chemical active material with the graphite composite material.

Accordingly, the present invention of multilayered electrode structure shall be incorporated into both positive and negative electrode plates of the lead acid battery.

### BRIEF DESCRIPTION OF THE DRAWINGS

Now the objects and the above features of the present invention will be briefly described with reference to the accompanying drawings.

FIG. 1A shows a negative grid in accordance with an exemplary embodiment of the present invention.

FIG. 1B shows a diagram in which graphite composite layer is adhered to the negative grid (substrate) as per the configuration of the present invention.

FIG. 1C shows the stages of the multilayered electrode (negative plate) preparation which involves the three layer namely first substrate layer, second transition layer of graphite composite material and third layer of chemically conductive material in accordance with the present invention.

FIG. 2 shows the flow chart illustrating the process flow of the Lead acid Battery in accordance with the present invention which includes the attachment of graphite composite and negative grids.

FIG. 3 shows a graph to illustrate the discharge data of the Lead acid Battery having an graphite composite layer in the negative electrode plate when the battery is subjected to 30 number of cycles of discharge.

FIG. 4 illustrates the graphical representation of comparison of Reserve capacity cycling of a regular lead acid battery with a lead graphite composite battery for almost 250 cycles.

FIG. 5 illustrates the graphical representation of the charging time Vs State of charge in comparison between lead acid and graphite composite battery.

### DETAILED DESCRIPTION OF INVENTION

In the following description, the purpose, operation and the features of the invention are explained in detail with reference to the drawings.

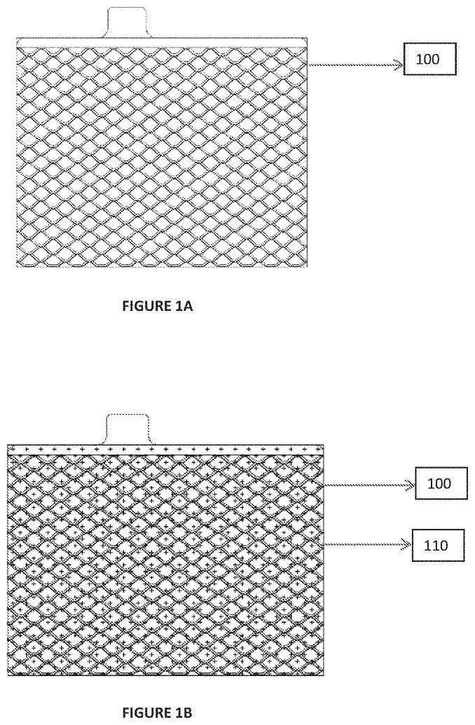

In accordance with the present invention, FIG. 1A and FIG. 1B illustrates a front view of negative grid and negative electrode plate which prepared by attaching the layer of graphite composite material to the negative grid respectively for electrode plate preparation for the lead acid battery assembly.

FIG. 1C illustrates the three stages of the negative electrode plate structure formed with the three layer containing the substrate layer, transition layer and chemically active conducting layer.

With reference to FIG. 1A to FIG. 1C of the present invention, an electrode plate preparation for the lead acid battery assembly includes one electrode plate which is prepared with a multilayered structure comprising a graphite composite material having higher electronic conductivity during charging and discharging of the battery assembly.

In one aspect of the present invention, the electrode plate structure formed is a three layered plate comprises a first base/substrate layer (100) made of electrically conductive material; a second transition layer (110) made of graphite composite material being adhered to the first base layer using an adhesive agent; and a third chemically active conductive layer (120) surrounding the second transition layer (110).

In another aspect of the present invention, the electrode plate structure prepared with this three layered structure is a negative electrode plate and it comprises the transition layer with the graphite composite material preferably having a thickness in the range of 0.1 to 0.5 mm.

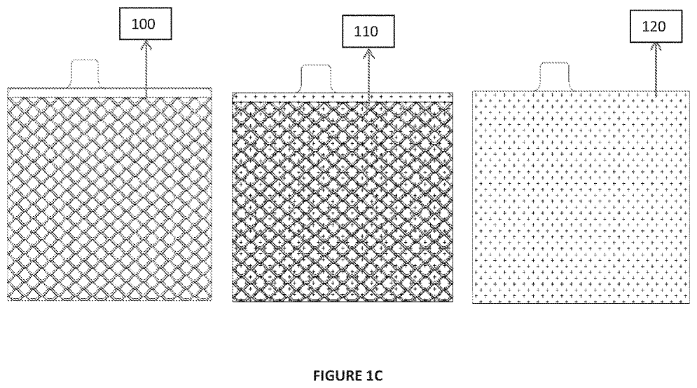

As shown in FIG. 2, according to one embodiment of the present invention, the method of electrode plate preparation for the lead acid battery assembly preferably comprises the step of:
preparing a positive grid and covering the positive grid by a paste of lead oxide (positive active material)
preparing a three layered negative electrode comprising
   forming the first substrate (negative grid) layer with flat structure made of lead;
   adhering/fixing a second transition layer of graphite composite using epoxy resin by cold pressing; and
   pasting the second transition layer with a negative active material (Pb) in order to hold the active material and to transfer the electricity to base layer of lead.

According to the present invention, in the two layered structure of negative plate preparation, the transition layer with graphite composite comprises the pure graphite 0.1 to 10% of weight (99.6% Carbon purity) which is graphitized with a base of any synthetic polymer material namely polyethylene, polyolefins, acrylic polymers such as PolyacryloNitrile (PAN) from 1 to 10% in order to enhance the electronic conductivity of the graphite.

As it is known, that graphite is a semi metal having its two inherent characteristic features namely (i) the layered structure which allows intercalation of materials and (ii) an amphoteric disposition affects the electrochemical behavior of graphite and exhibit remarkable properties during charging and discharging of the plate in the battery.

According to the invention, the flexible graphite composite layer is first adhered to lead grid (substrate) layer with help of epoxy resin, in order to provide the mechanical strength to withstand pressure during pasting. Once both the layers are adhered active material is applied on the top of the graphite composite and the entire plate thus obtained will be sent for curing where humidity and temperature is induced to get bonding and strength for the plate of battery assembly.

The second layer of graphite composite material is prepared by treating the carbon felt material at higher temperatures beyond 2000 degree celsicus and preferably from 2000 degree celsicus up to 2800 degree celsicus through a graphitization process. This prepared graphite composite material provides the structure of graphite with carbon fibers which is sturdy in compared to the known used carbon and graphite soft felt structure. Conventionally, the usual carbon soft felt is prepared from needled cellulose fibers by thermal treatment at 800-1000 degree Celsicus.

The negative plate of the battery is prepared with the structural layer of this graphite composite material may well have an electrical resistivity value between 0.15 to 0.25 μOhm. (very low resistivity for higher conductivity) and a density of 0.11 gm/cm3 to 0.15 (of less weight).

While charging the graphite material in the negative grid ensures the uniform current distribution all over the plate with very less resistance. At the same time, it has an excellent acid absorbent characteristic since it allows free ionic transfer. This uniform current distribution will charge battery faster and more efficiently.

As per the invention, the graphite composite layer which incorporated in the plates of the electrode function as a stabilizer since this material eliminates the accumulation of sulphate formed in the negative plate during the PSOC operation by separating the crystals of PbSo4 from the plates and enabling the availability of electrolyte for the recharge reaction without the loss of water. Consequently, the graphite composite layer is effective in improving the conductivity during charging/discharging and also will not degrade the adhesion property of graphite with substrate layer and the chemically active material.

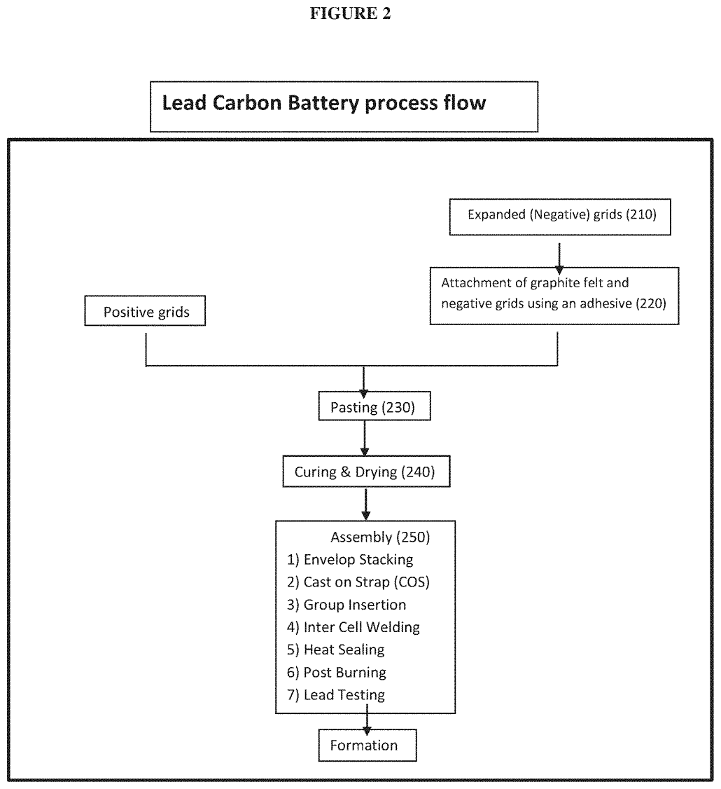

The manufacturing method of battery assembly with two numbers of 2V cells with the presence of different graphite composite material thickness in the layer of electrode plate preparation improves the battery performance. It provides good bondage between graphite composite and the lead sheet. Batteries when subjected to CIO capacity discharge for a number of cycles and the data is noted. The discharge data can be seen in the graph shown FIG. 3.

The plate preparation with grids having graphite composite material with thickness in the range of 0.1 to 5.0 mm increases the cyclic life of the battery than the usual lead acid battery provides 100% DOD (depth of discharge—how deeply the battery is discharged) even after 50 cycles of discharge and there is no significant reduction in capacity. The charge acceptance of the battery has been increased by 20% to that of a normal lead acid battery.

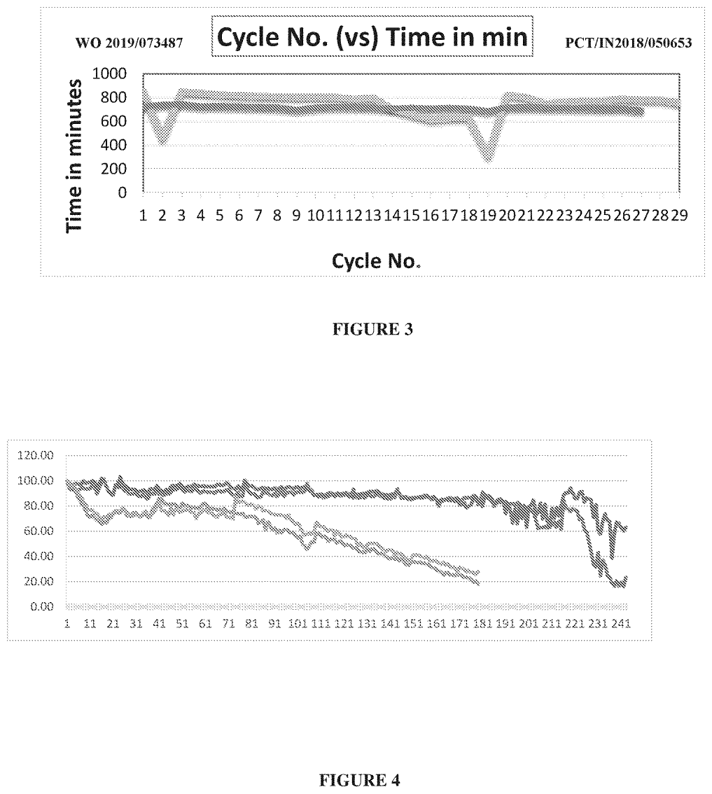

FIG. 4 denotes that 20% less input for formation charging than conventional lead acid battery (300 ah/kg PAM). Since the resistance offered by graphite composite material at negative plate is too low, the initial charging is effectively utilized thereby increasing the formation efficiency.

It is observed that almost 50% improved cyclic life at 80% Depth of discharge (DOD) compared to regular lead acid battery. In a regular flooded battery with the above graphite composite material in the negative plate electrode, during Reserve Capacity cycling it is observed that the battery is giving a life of 400 to 500 cycles before reaching to a capacity of 50% compared to that of 200 to 250 in case of regular flooded lead acid battery with conventional design.

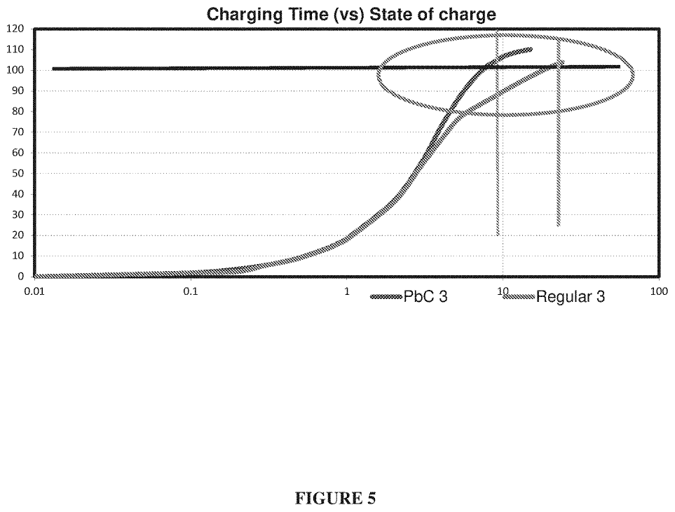

Furthermore, FIG. 5 shows the graph of charging time required to reach state of charging (SOC) in accordance with the claimed graphite composite material in the negative electrode plate of the battery. It indicates 30% faster charging in constant voltage charging mode. Batteries are reaching 100% SOC (state of charging) in batteries with graphite electrode where as it is taking more than 11 hours in case of conventional VRLA (Valve regulated Lead acid assembly).

Additionally, it is observed that recovery from deep discharge is 20% more efficient than conventional lead acid battery. When subjected to capacity discharge after deep discharging the graphite electrode battery, it is recovered to 100% of Original test capacity whereas conventional battery has reached only to 80% of its original test capacity. It is also identified that Partial state of charge application is almost 100% better than conventional lead acid battery when discharged at 20% DOD the cyclic life of the lead carbon battery is almost double to that of a conventional lead acid battery.

### Advantages

1. The graphite composite material used is much cheaper than the carbon foam used by the competitors.
2. Graphite composite material is having excellent acid absorption capability than the carbon foam which will definitely enhance acid retaining capacity.
3. The Lead Tin alloy will maintain stability during cycling.
4. Lead paste is having an excellent adhesion with the active material existing within the graphite foam and forming bond like a regular plate.
5. This plate preparation can be utilized in almost all of the existing lead acid battery manufacturing.
6. Current distribution is much more even in graphite composite material than that of the carbon foam.
7. Graphite composite material has an excellent acid absorption characteristic which is helpful to prevent acid stratification & also reduces water loss.
8. Graphite composite material is sturdy whereas carbon foam grid is very brittle.

It is to be understood that the description and the claims are not limited to the specific configuration and components illustrated above. Various modifications, changes and variations may be made in the arrangement, operation and details of the method of manufacturing described above without departing from the scope of the claims

1. A lead acid battery assembly comprising
a housing;
a plurality of cells disposed within the housing, each cell having two electrodes namely positive plate and negative plate, both placed in a volume of an electrolyte in the housing and wherein the cell formed comprises at least one electrode plate prepared with a multilayered structure comprising a graphite composite material having higher electronic conductivity during charging and discharging of the battery assembly.

2. The battery assembly as claimed in claim 1, wherein the electrode plate structure formed is a three layered plate comprising
a first base/substrate layer (100) made of electrically conductive material;
a second transition layer (110) made of graphite composite material being adhered to the first base layer using an adhesive agent; and
a third chemically active conductive layer (120) surrounding the second transition layer (110).

3. The battery assembly as claimed in claim 1, wherein in the electrode plate preparation, the graphite composite material has a thickness in the range of 0.1 to 0.5 mm.

4. The battery assembly as claimed in claim 1, wherein the graphite composite material comprises pure graphite 0.1 to 10% weight (99.6%) carbon purity material, which is graphitized with a base of a synthetic polymer material selected namely from polyolefin, polyethylene, acrylic polymers such as polyacrylonitrile (PAN), Rayon etc., in 1 to 10% weight.

5. The battery assembly as claimed in claim 1, wherein the electrode plate formed is a negative plate which comprises a negative grid made of lead as the first substrate layer and a negative active material made from lead as the third layer is pasted on the second transition layer of graphite composite material.

6. The battery assembly as claimed in claim 1, wherein the cell comprises a positive electrode plate formed with a positive grid made of lead alloy and a layer of positive active material namely lead oxide pasted on the positive grid.

7. The battery assembly as claimed in claim 1, wherein the graphite composite material has an electrical resistivity value between 0.15 to 0.25 μOhm.

8. The battery assembly as claimed in claim 1, wherein the graphite composite material has a density of 0.11 gm/cm3 to 0.15.

9. A method of manufacturing a lead acid battery assembly (250) comprising
preparing at least one electrode plate with a three layered structure includes the steps of
providing (210) the first substrate/grid layer made of electrically conductive material;
adhering/fixing (220) a second transition layer having graphite composite material to the first substrate layer using epoxy resin by cold pressing;
pasting (230) the second transition layer with a chemically active material in order to hold the active material and to transfer the electricity to the substrate layer; and
curing (240) the pasted chemically active material.

10. The method as claimed in claim 9, wherein the electrode plate formed is a negative plate which comprises a negative grid made of lead as the first substrate layer and a negative active material made from lead as the third layer is pasted on the second transition layer of graphite composite material.

11. The method as claimed in claim 9, wherein the graphite composite material is a layered structure formed with graphite felt carbon material which is prepared by graphitization process, when the carbon material is heated at a temperature of more than 2200° C.

12. The method as claimed in claim 9, wherein the graphitized carbon felt structure is prepared by heating the carbon material preferably at a temperature from 2200° C. to 2800° C.

13. The method as claimed in claim 9, wherein the method comprises the step of preparing a positive plate by providing a positive grid made of lead alloy and pasting a layer of positive active material namely lead oxide on the positive grid.
